(19) United States
(12) Patent Application Publication
(10) Pub. No.: US 2006/0016921 A1
(43) Pub. Date: Jan. 26, 2006

(54) Apparatus for the processing of foodstuffs

(76) Inventor: Josef Vacha, Kostelec nad Orlici (CZ)

Correspondence Address: Peter R. Ruzek, 24 Green Woods Lane, Farmington, CT, 06085, US

(21) Appl. No.: 11/148,793

(22) Filed: Jun. 8, 2005

(30) Foreign Application Priority Data
Jun. 8, 2004 (CZ) PUV 2004-15519

(51) Int. Cl. B02C 19/00

(52) U.S. Cl. 241/82.1; 241/101.2

(57) ABSTRACT

An apparatus for processing, such as grinding, crushing or otherwise comminuting and/or mixing, foodstuffs includes, as its main constituents, a foodstuff processing device of the type originally equipped merely with a hand crank for manual operation, an external power drive, and a transmission unit interposed between the former and the latter and transmitting torque between the two. The transmission unit includes a worm and a worm wheel accommodated in a transmission casing and meshing with one another, with the worm being driven by the power drive, such as a power drill, and the worm wheel driving the food processing device. The transmission unit is secured to the device so as not to move relative thereto, and the power drive is connected to the transmission casing so as to retain its position relative thereto and hence also to the foodstuff processing device.

### BACKGROUND OF THE INVENTION

1. Field of the Invention

The present invention relates to apparatus for the processing of foodstuffs in general, and more particularly for the home processing of foodstuffs involving grinding, crushing or otherwise comminuting and/or mixing.

2. Description of Related Art

Currently, various devices, machines or apparatuses designed to be used for the processing of foodstuffs are already known and in widespread use. Based on the sites and manners of their use, such devices can be categorized as industrial, on the one hand, and domestic, on the other. While the industrial devices of this kind are generally driven by electric motors or similar drives, domestic devices of this type are either powered or driven by built-in electric drives, or are in many instances equipped to be operated only manually.

One of the best known manually operated devices of the type here under consideration is a kitchen grinding machine, the main components of which are usually made of cast iron.

Czech utility model publication CZ 13632 U1 discloses a manual poppy-seed grinder that includes a grinder body connected with a clamping arrangement, a hopper, and grinding equipment rotatably mounted in the grinder body and including a grinding cone with rotary grinding segments formed by alternating grooves and grinding ridges of generally triangular cross-sections, and further a worm-gear part and a rotatably supported clamping stud terminated by a threaded portion on which a crank equipped with a handle is supported at the exterior of the grinder body via a supporting ring, and onto which a spring nut is screwed on.

Another device for domestic grinding is disclosed in the U.S. Pat. No. 5,970,860, in which a grinding equipment is housed in the body of the grinding apparatus, this grinding equipment being powered or driven by means of a crank provided with a handle. The body of the grinding device is connected with a stand equipped with a suction element by means of which the device is attached to a work desk or board or a similar support.

The Czech utility patent application CZ 13700 U discloses and arrangement in which of an electrically powered foodstuff processing appliance is supplemented with an auxiliary gear unit. Conventional kitchen appliances of the type addressed here are usually capable of operation at merely two speed levels; the use of such an auxiliary transmission makes it possible to increase the number of operating speeds. The main reason behind this known construction is the expansion of the possibilities of use of the appliance.

A conventional grinding machine is also disclosed in the Russian patent publication RU 2059400. This publication discloses an apparatus in the body of which an auger is arranged that has a cutting blade with a specific shape of its cutting portion. This apparatus is also operated by means of a crank equipped with a handle.

It may be seen from the above explanation that there exist, on the one hand, large industrial machines and, on the other, domestic machines with either built-in electrical drives or, more often than not, with only manual driving arrangements. Electrically driven domestic devices or appliances usually have a rather delicate construction, which makes them usable only in domestic applications. The much sturdier crank-type manual machines can be used anywhere, but their throughput is limited precisely by their manual operation. This constitutes a pronounced drawback, the same as that encountered when a higher throughput is temporarily required in a household use.

### SUMMARY OF THE INVENTION

It is a general object of the present invention to avoid the disadvantages of the prior art.

More particularly, it is an object of the present invention to develop an apparatus of the type here under consideration that does not possess the disadvantages of the conventional apparatuses of this kind.

A further object of the present invention is to modify the conventional manually operable device for the processing of foodstuffs in such a manner as to enhance its versatility in terms of utilization and throughput relative to otherwise similar known devices.

Still another object of the present invention is to enable the device of the above type to be used in a more facile and expeditious manner than heretofore possible.

In pursuance of these objects and others that will become apparent hereafter, one feature of the present invention resides in an apparatus for the processing of foodstuffs, especially for the domestic processing of foodstuffs involving grinding, crushing or otherwise comminuting and/or mixing. According to the invention, the apparatus includes, in combination, an originally only manually operable foodstuff processing device; an auxiliary power drive external to the device; and a transmission unit also external to the device, interposed between the auxiliary power drive and the device, and operative for transmitting power from the former to the latter.

A particular advantage of the apparatus as described so far is that, as a result of combining the originally only manually operable (by a crank equipped with a handle) food processing device with an auxiliary power drive and an external transmission unit operatively interposed between the auxiliary power drive and the device (replacing the handle-equipped crank), not only is the user of the apparatus spared the heretofore necessary physical exertion, but also, and possibly even more importantly, the food processing operation is improved at least as far as its expeditiousness (i.e. throughput of the device) is concerned, under conditions that can be carefully controlled by the user of the apparatus.

Advantageously, the transmission unit includes a casing consisting of respective interconnected front and rear parts, and a worm gear train including a worm and a worm wheel accommodated in the casing and meshing with one another. The apparatus further includes means for connecting the worm wheel with the device and the worm with the auxiliary power drive.

It is currently considered to be most advantageous when the transmission unit further includes a sliding bearing supporting the worm in the casing and/or at least one rolling bearing supporting the worm wheel in the casing.

According to another advantageous facet of the invention, the aforementioned connecting means includes primary connecting means for connecting the worm wheel with an externally accessible end portion of a shaft of the device on which the handle-equipped crank used to be mounted. Generally speaking, it is advantageous for the primary connecting means to connect the transmission unit with the device in the same or a similar manner as the heretofore solely used crank. To this end, the primary connecting means may include a connecting element including a threaded shank that is threaded into the end portion of the device shaft and a head abutting the worm wheel.

To advantage, the transmission unit further includes a supporting sleeve surrounding the device shaft end portion, with the worm wheel being mounted on the supporting sleeve, and with at least one key being provided to connect the worm wheel with the supporting sleeve at least for joint rotation with one another. The supporting sleeve is configured in such a manner that the key fits into it with no, or only a minimum, leeway. In an advantageous embodiment, the supporting sleeve is provided with a passage delimited by a generally conical surface that abuts a corresponding surface formed on the device shaft end portion.

The worm advantageously has a shaft end portion protecting out of the casing; and the connecting means includes secondary connecting means for connecting the auxiliary power drive with the aforementioned shaft end portion of the worm.

The transmission unit may further include at least one screw connecting the front and rear parts of the casing with one another

For stabilizing the entire transmission unit on the device, the rear part of the casing is provided with a bifurcated portion that engages a mounting portion by means of which the device is mounted on a support

It is especially advantageous when the auxiliary power drive is constituted by a readily available drive, such as a power drill or a similar power tool, because such a power drive is usually capable of gradually varying its output speed to enable the user to adjust it to the particular requirements. Moreover, such a power drive can easily be connected to the worm shaft end portion by using the chuck of the power drive as the secondary connecting means.

It is also advantageous when, in accordance with the invention, means is provided for holding the auxiliary power drive in a predetermined position relative to the transmission unit and to the device. Such holding means may be tailored to the particular power drive to be used. According to another facet of the present invention, the holding means includes a holding element for engaging the auxiliary power drive, a clamping bracket having a protuberance abutting a corresponding portion of the rear part of the casing, and a clamping screw threaded into the front part of the casing and engaging the clamping bracket, causing the latter to clamp the holding element between itself and the casing.

Last but not least, in accordance with yet another facet of the invention a filling hopper is provided, being situated at a pour-in opening located at an upper region of the foodstuff processing device. The provision of this hopper is especially advantageous for safety reasons, taking into consideration the fact that the previously solely used manual drive is at least from time to time replaced by a power drive train. The filling hopper may include a lid-like interface region juxtaposed with the device at and around the pour-in opening, and at least three clasps mounted on the interface region and externally engaging the device at the region of and around the pour-in opening. The filling hopper may advantageously include a tubular part juxtaposed with the device at and around the pour-in opening, a filling part remote from the device and enlarged relative to the tubular part, and a transition part located between and gradually merging with the tubular part and the filling part.

The apparatus for the preparation of foodstuffs as proposed by the present invention makes it possible, in a simple and inexpensive manner, to considerably increase the throughput of conventional manually operated foodstuff preparation machines. The construction of the apparatus as a whole makes possible its use even under conditions for which the conventional kitchen appliance of this sort are not designed and in which they, consequently, could be rather rapidly damaged or even destroyed.

### BRIEF DESCRIPTION OF THE DRAWING

Further details of the present invention will become readily apparent from the accompanying drawing, in which:

FIG. 1 is a side elevational view of the foodstuff processing apparatus of the present invention, with a transmission unit forming a constituent component of the apparatus being shown in cross-section;

FIG. 2 is a top plan view of the apparatus of FIG. 1 but also showing another constituent component of the apparatus, namely a power drive; and

FIG. 3 is a front end view of the apparatus of FIGS. 1 and 2, showing the transmission unit in a longitudinal section but with both the food processing device and the power drive omitted for the sake of clarity.

### DETAILED DESCRIPTION OF THE PREFERRED EMBODIMENT OF THE INVENTION

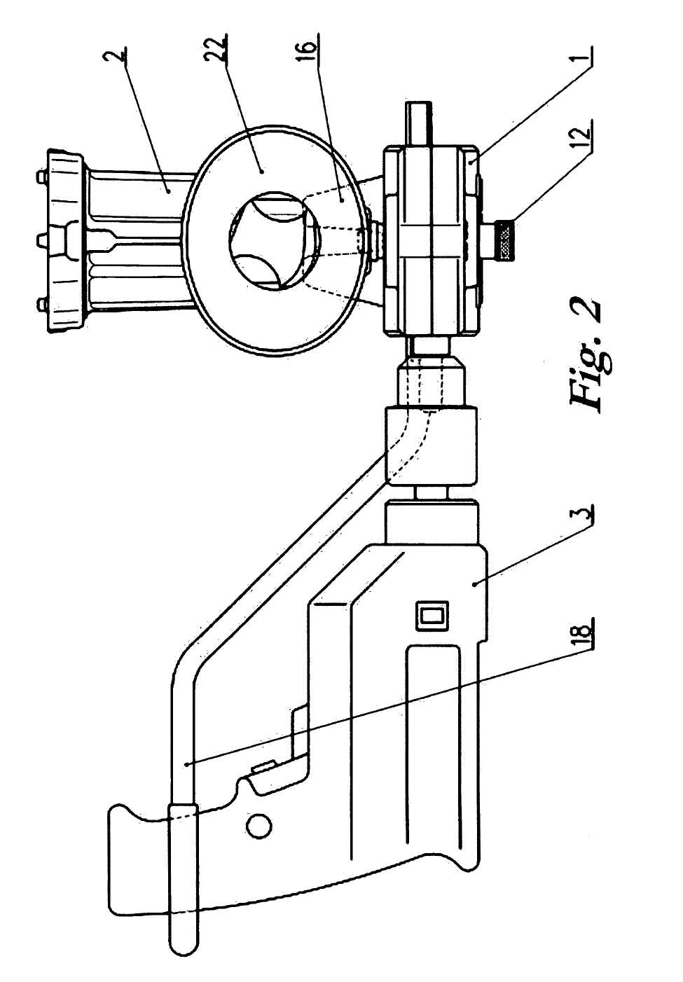

Referring now to the drawing in detail, and first to FIG. 2 thereof, it may be seen that the apparatus for the processing of foodstuffs in accordance with the present invention includes three basic constituent components, namely a foodstuff processing device 2, an external power drive 3 and a transmission unit 1 that is also separate from and external to the device 2. The transmission unit 1 is interposed, and transmits torque, between the power drive 3 and the device 2. The device 2 is of the type that was designed for, and is customarily used with, a crank equipped with a handle (not shown) in a manual operation.

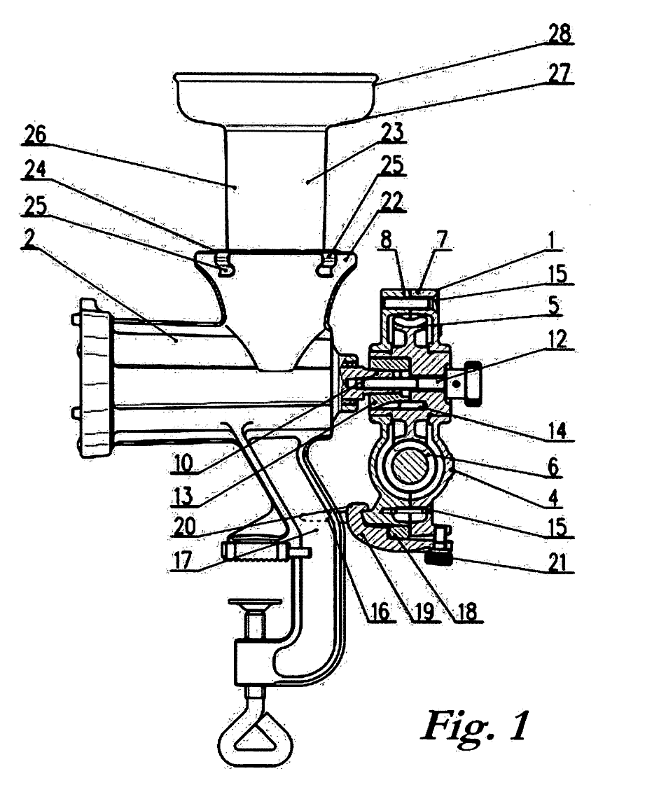

The transmission unit 1 includes, as illustrated particularly in FIG. 1 of the drawing, a transmission casing 4 that is composed of two separate parts that are referred to herein as the “front” and “rear” parts 7 and 8, respectively; however, it is to be understood that this and any other possible references to orientation are to be construed as relating to only one possible way of viewing the apparatus in its currently preferred position of use, namely where the user or observer of the apparatus is situated in front of a support (working board, table, desk or the like, neither one of which is shown) on which the device 2 is mounted when in use, i.e. also in front of the “front” part of the transmission casing 4.

A worm wheel 5 and a worm 6, which mesh with one another, are accommodated and supported for rotation about their respective axes of rotation in the interior of the transmission casing 4, forming a gear train or, speaking generally, a transmission train. The worm wheel 5 is connected to the device 2, whereas the power drive 3 is connected to the worm 6.

The worm wheel 5 is supported in the transmission casing 4 by a sliding bearing, whereas the worm 6 is supported in the transmission casing 4 by means of a pair of rolling (as shown, ball) bearings 9. The worm 6, inclusive of the bearings 9, is sealed relative to the exterior of the transmission casing 4 by means of a pass-through lid 29 and another lid 30.

The transmission unit 1 is connected to the food processing (e.g. grinding) device 2 by means of a threaded fastener 12 (e.g. a machine screw or bolt) having a head that abuts the worm wheel 5 and a threaded shank that is threaded into a complementarily threaded bore in an end portion 10 of a shaft that is accessible from the exterior of the device 2. The worm wheel 5 is supported on the externally accessible (actually outwardly projecting) end portion 10 of the shaft of the device 2 by means of a sleeve 13 that is secured to the worm wheel 5 by a key 14. In the sleeve 14, a conical passage is formed that is delimited by a surface 31 that engages a correspondingly configured and situated surface present on the end portion 10 of the device shaft.

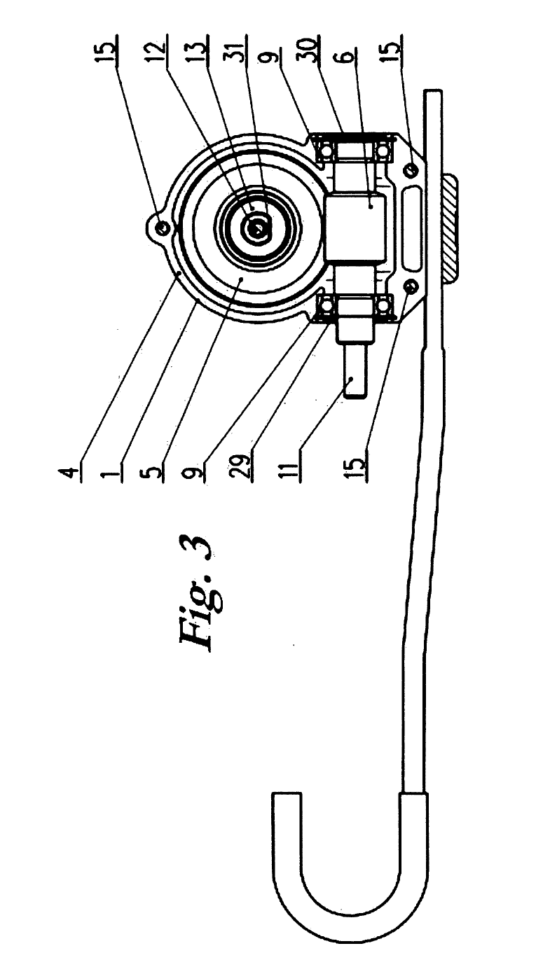

The front part 7 and the rear part 8 if the transmission casing 4 are connected to one another by at least one connecting element or screw 15 (two shown in FIG. 3 of the drawing). A bifurcated portion 15 is formed on or otherwise securely connected with the rear portion 8 of the transmission casing 4, and it engages a mounting portion 17 of the device 2.

As illustrated, the power drive 3 is constituted by a power drill that is connected, by means of its chuck, in a torque-transmitting relationship, with a corresponding end portion 11 of the worm 6. The power drive 3 is supported on holding arm 18.

The holding arm 18, the main purpose of which is to hold the power drive 3 in a predetermined spatial relationship with respect to the transmission unit 1 and hence also the device 2, is connected with the transmission unit 1 by means of a clamping bracket 19 in such a manner that the clamping bracket 19, a protuberance 20 of which abuts the bifurcated portion 16 of the transmission casing 4 in the illustrated embodiment, and which is connected by a clamping screw 21 to the front part 7 of the casing 4, clamps the intervening portion of the holding bracket 18 between itself and the transmission casing 4.

At the region of a pour-in opening 22 of the device 2, there is arranged a filling hopper or funnel 23. The hopper 23 includes a lid-like interface region 24 that is juxtaposed with the device 2 at and around the pour-in opening 22. The interface region 23 is equipped with at least three clasps 25 that engage the exterior of the device 2 at and around the region of the pour-in opening 22. The hopper 23 includes a tubular portion 26 that is close to the device 2 and a more remote filling portion 28 that is enlarged with respect to the tubular portion 26, with a transition region 27 being located between and smoothly or gradually merging with the tubular portion 26 and the filling portion 28.

Without further analysis, the foregoing will so fully reveal the present invention that others can, by using ordinary skill in the art, readily adapt it for various applications within the scope of the present invention.

While the present invention has been described and shown as embodied in a foodstuff processing apparatus, such as a poppy-seed grinder, it will be appreciated that the present invention is not, nor is it intended to be, limited to the details shown; rather, all variations within the general concept of the following claims are to be considered to be embraced by the present invention. So, for instance, the transmission unit and the power drive could be used, in the manner disclosed here, with other types of previously manually operated household devices or machines, such as meat or nut grinders, pasta makers, etc. Also, the transmission unit could be of a different type, for instance using a belt trained around corresponding pulleys instead of the meshing gears.

What is considered to be novel and original and desired to be protected by a Letters Patent will become apparent from the following claims:

1. An apparatus for the processing of foodstuffs, especially for the domestic processing of foodstuffs involving grinding, crushing or otherwise comminuting and/or mixing, comprising, in combination, an originally only manually operable foodstuff processing device (2); an auxiliary power drive (3) external to said device (2); and a transmission unit (1) also external to said device (2), interposed between said auxiliary power drive (3) and said device (2), and operative for transmitting power from the former to the latter.

2. The apparatus as defined in claim 1, wherein said transmission unit (1) includes a casing (4) consisting of a front part (7) and a rear part (8), and a worm gear train including a worm (6) and a worm wheel (5) accommodated in said casing (4) and meshing with one another; and further comprising means for connecting said worm wheel (5) with said device (2) and said worm (6) with said auxiliary power drive (3).

3. The apparatus as defined in claim 2, wherein said transmission unit (1) further includes a sliding bearing supporting said worm (6) in said casing (4).

4. The apparatus as defined in claim 2, wherein said transmission unit (1) further includes at least one rolling bearing (9) supporting said worm wheel (5) in said casing (4).

5. The apparatus as defined in claim 2, wherein said device (2) includes a shaft having an externally accessible end portion (10); and wherein said connecting means includes primary connecting means for connecting said worm wheel (5) with said end portion (10).

6. The apparatus as defined in claim 5, wherein said primary connecting means includes a connecting element (12) including a threaded shank that is threaded into said end portion (10) and a head abutting said worm wheel (5).

7. The apparatus as defined in claim 5, wherein said transmission unit (1) further includes a supporting sleeve (13) surrounding said end portion (10); wherein said worm wheel (5) is mounted on said supporting sleeve (13); and wherein said transmission unit (1) further includes at least one key (14) connecting said worm wheel (5) with said supporting sleeve (13) at least for joint rotation with one another.

8. The apparatus as defined in claim 2, wherein said worm (6) includes a shaft end portion (11) projecting out of said casing (4); and wherein said connecting means includes secondary connecting means for connecting said auxiliary power drive (3) with said shaft end portion (11).

9. The apparatus as defined in claim 2, wherein said transmission unit (1) further includes at least one screw (15) connecting said front part (7) and said rear part (8) of said casing (4) with one another.

10. The apparatus as defined in claim 2, wherein said device (2) includes a mounting portion (17) for mounting said device (2) on a support; and wherein said rear part (8) of said casing (4) includes a bifurcated portion (16) that engages said mounting portion (17).

11. The apparatus as defined in claim 1, wherein said auxiliary power drive (3) is constituted by a power drill.

12. The apparatus as defined in claim 1; and further comprising means (18) for holding said auxiliary power drive (3) in a predetermined position relative to said transmission unit (3) and to said device (2).

13. The apparatus as defined in claim 12, wherein said holding means includes a holding element (18) for engaging said auxiliary power drive (3), a clamping bracket (19) having a protuberance (20) abutting a corresponding portion of said rear part (8) of said casing (4), and a clamping screw (21) threaded into said front part (7) of said casing (4) and engaging said clamping bracket (19), causing the latter to clamp said holding element (18) between itself and said casing (4).

14. The apparatus as defined in claim 1, wherein said foodstuff processing device (2) has a pour-in opening (22) at an upper region thereof; and further including a filling hopper (23) situated at said pour-in opening (22).

15. The apparatus as defined in claim 14, wherein said filling hopper (23) includes an interface region (24) juxtaposed with said device (2) at and around said pour-in opening (22), and at least three clasps (25) mounted on said interface region (24) and externally engaging said device (2) at the region of and around said pour-in opening (22).

16. The apparatus as defined in claim 14, wherein said filling hopper (23) includes a tubular part (26) juxtaposed with said device (2) at and around said pour-in opening (22), a filling part (28) remote from said device and enlarged relative to said tubular part (26), and a transition part (27) located between and gradually merging with said tubular part (26) and said filling part (28).

17. A transmission unit for use in an apparatus for the processing of foodstuffs, especially for the domestic processing of foodstuffs involving grinding, crushing or otherwise comminuting and/or mixing, in conjunction with an originally only manually operable foodstuff processing device and an auxiliary power drive external to the device, said transmission unit (1) being separate from and also external to the device (2) and including a casing (4); a transmission train (5, 6) mounted in said casing in torque-transmitting relationship; means for connecting said casing (4) with the device (2) and the auxiliary power drive (3) so as to be interposed between the device (2) and the auxiliary power drive (3); and means for transmitting torque from the auxiliary power drive (3) to said transmission train (5, 6) and from said transmission train (5, 6) to the device (2).

18. A method of operating an apparatus for the processing of foodstuffs, especially for the domestic processing of foodstuffs involving grinding, crushing or otherwise comminuting and/or mixing, comprising the steps of attaching an external transmission unit in a torque-transmitting relationship to the device; connecting an external auxiliary power drive in a torque-transmitting relationship to the transmission unit; and energizing the external auxiliary power drive to power the device through the external transmission unit.
